(19) United States
(12) Patent Application Publication
(10) Pub. No.: US 2009/0258656 A1
(43) Pub. Date: Oct. 15, 2009

(54) Method for Exchanging Location-Relevant Information Using a Mobile Device with an Interactive Map Display

(76) Inventors: Yin Wang, Medford, MA (US); Tao Jin, Medford, MA (US)

Correspondence Address: Russ Weinzimmer, 614 Nashua Street, Suite 53, Milford, NH, 03055, US

(21) Appl. No.: 12/101,998

(22) Filed: Apr. 13, 2008

(51) Int. Cl. H04W 4/02

(52) U.S. Cl. 455/456.1

(57) ABSTRACT

A method is disclosed for wirelessly providing easily accessed and comprehended location-relevant information to a mobile device or web browser by displaying a map showing locations of interest. Simply by touching the map, a user can specify locations and regions used for queries and for uploading peer-to-peer information such as blogs, reviews, items for sale, etc. The device can request information, receive synchronously or asynchronously pushed responses, and display them with symbols that indicate category, age, etc. Location-aware devices can automatically specify their locations and provide location histories. Regions of interest can be adjusted according to visitation frequency, or region boundaries can simply be traced on the map. Limits can be placed on requested information and on distribution of uploaded information. Queries can use fuzzy logic, transactions can be completed using the devices, and requested information can be delivered when battery charge level and wireless link quality are appropriate.

### FIELD OF THE INVENTION

The invention generally relates to information exchange, and more specifically to the exchange of location-relevant information.

### BACKGROUND OF THE INVENTION

Location is often a highly important criterion when seeking and/or exchanging certain kinds of information. One example is when information is being sought regarding local business establishments. If an individual is hungry and is seeking a restaurant, the single most important criterion is that the restaurant must be located reasonably close to the individual's current location. Otherwise, it is not a suitable candidate, no matter how perfect it may be in other respects. Similarly, location is a highly important criterion when seeking a hotel, a store, a gas station, an apartment for rent, and such like. If the establishment is too far away from a user's current location, or from locations that the user frequents, then it is usually irrelevant.

Location is also a significant factor when information is exchanged between peers. An individual may have an item for sale, a service to provide, or a room for rent. Or an individual may simply wish to provide a review or opinion regarding a local store, restaurant, or event. Such information is highly location-relevant. For example, a recent review by a patron of a nearby restaurant could be of great interest, while a review of a restaurant located hundreds of miles away is of little interest.

Given enough time and foresight, there are many approaches that can be used to obtain and exchange “location-relevant” information. Traditional methods include searching through telephone books and local newspapers, placing and reading classified ads, sending and receiving newsletters and fliers by mail, and posting and reading fliers at public places. These approaches are clearly limited, since they require time consuming searches through paper documentation that is not highly location specific.

More recent and improved approaches involve using a computer to exchange information and/or search data storage servers over the internet. Location-relevant information can be accumulated in a data storage server, and then queries can be executed on the data storage server over the internet so as to identify hotels, stores, and such like according to their distance from a specified location of interest. For example, when seeking a hotel near a certain location of interest, a zip code or an address can be supplied to an internet site such as Hotels.com, Expedia.com, or Travelocity.com, and a list of hotels near the location of interest can be thereby obtained, including a map that indicates the locations of the hotels relative to the specified zip code or address. Similarly, location-relevant, peer-to-peer information can be exchanged over the internet by emails, online news groups, and through peer-to-peer advertising on internet sites such as Google, Yahoo, eBay, and Craig's List.

However, these internet approaches are limited in several ways. Advance planning is usually needed, because they require use of an internet-capable device, such as a personal computer, and the device requires an active connection to the internet. A need to obtain information in advance requires time and planning and hampers the spontaneous obtaining of location-relevant information. A need to obtain such information in advance can also lead to obtaining information that may not be current by the time it is used, since location-relevant information can change unpredictably with time. These approaches also require accurate knowledge and entry of the location of interest, which can be a limitation when an individual is seeking information relevant to his or her current location, and the individual is not at home or at some other familiar location such as a place of work.

One approach to providing more flexible and mobile access to location-relevant information is to use wireless communication to exchange information between a data access server and a mobile computing device such as a cell phone (e.g. a Blackberry or iPhone), an MID (mobile internet device), a UMPC (ultra-mobile PC), etc. Such devices are often “location-aware,” in that they include a GPS or can determine at least their approximate location by another means such as detecting WiFi AP's or cellular telephony Cell ID's. Or a location aware device may simply be able to report information such as a detected WiFi AP or Cell ID which can then be used by a server in communication with the device to determine at least its approximate location. Using a location aware device can greatly simplify the process of requesting information relevant to the current location of the device. Through so-called “location-based advertising,” this approach can provide location-relevant information at the push of a button such as a list of nearby restaurants or gas stations, even when the user is only vaguely aware of where he or she is. It has also been suggested that such an approach could be used to provide location-relevant, peer-to-peer information.

However, mobile computing devices typically include only limited input and display capabilities, and this hampers their ability to provide easily accessed and readily understandable information regarding locations of interest and related information. And if information is desired that is relevant to a location or region other than the current location or region of the device, these user interface limitations can hamper the input of information regarding the location or region of interest.

### SUMMARY OF THE INVENTION

A method is claimed for providing location-relevant information by wireless communication to a mobile device in a manner that provides for easy access to and comprehension of the information on the mobile device. A map is displayed on the device with locations of interest indicated thereon, and selection of a location on the map provides detailed information pertaining thereto. In preferred embodiments, the method also provides for easy specification on the map of locations and regions of interest. This allows a user to easily generation location-relevant queries, and to provide peer-to-peer, location-relevant information for access by other users.

In one general aspect of the invention, the method includes providing a data exchange core with at least one data storage server that is able to receive, store, and update location-relevant information and perform queries thereon; the data exchange core being able to wirelessly communicate with the mobile computing device. A mobile client software system is provided that includes a set of instructions for controlling the mobile computing device, the mobile client software system being able to request location relevant information from the data exchange core, receive location-relevant information from the data exchange core, display a map on a display screen of the computing device, and identify on the map at least one location that corresponds to location-relevant information received from the data exchange core.

In preferred embodiments implemented on a mobile computing device that is location-aware, the mobile client software system is able to automatically provide to the data exchange core information allowing determination of at least the approximate location of the mobile computing device. And in some of these preferred embodiments the mobile client software system and/or the data exchange core is able to accumulate and store information allowing identification of a plurality of at least approximate locations of the mobile computing device for later transmission to the data exchange core.

In certain preferred embodiments, the mobile client software system is able to request from the data exchange core location-relevant information that is limited to at least one of the following: information belonging to a specified category; information that is relevant during a specified time period; information supplied by members of a specified group; information containing a specified key word; information to which a specified tag applies; and information to which a rating has been assigned, the rating being higher than a specified threshold.

In preferred embodiments the mobile client software system is able to accept input from a user specifying a location of interest. And in some of these preferred embodiments the location of interest can be specified by the user by at least one of the following: using a pointing system included in the computing device to select the location of interest on a map displayed on the screen; if the mobile computing device is location-aware, specifying that the current location of the mobile computing device is the location of interest; specifying that the location of another mobile computing device is the location of interest; and entering alphanumeric input into the mobile computing device that defines the location of interest.

In certain preferred embodiments, the mobile client software system is able to accept input from a user specifying a plurality of locations of interest. And in some of these preferred embodiments the locations of interest can be specified by the user by at least one of the following: specifying that locations visited by the mobile computing device are locations of interest; specifying that locations frequently visited by the mobile computing device are locations of interest; specifying that locations visited by another mobile computing device are locations of interest; specifying that locations frequently visited by another mobile computing device are locations of interest; and specifying that all locations belonging to a specified category are locations of interest.

In various preferred embodiments, the mobile client software system is able to accept input from a user specifying at least one region of interest, and the mobile client software system is able to request location-relevant information from the data exchange core pertaining to locations within each specified region of interest. In some of these preferred embodiments where the user is also able to specify a location of interest, at least one region of interest can be specified by a user specifying at least one location of interest and then allowing either the mobile client software system or the data exchange core to define a region of interest according to each specified location of interest, either by applying a specified radius to each location of interest or by combining roadway awareness with a specified travel time or a specified travel distance so as to define a region of interest surrounding each location of interest. And in some of these preferred embodiments, if the mobile computing device is location aware, the mobile client software system and/or the data exchange core can automatically maintain a history of time spent by the mobile computing device at locations, and the size of a region of interest surrounding a specified location of interest can be automatically adjusted according to the amount of time spent by the mobile computing device at the location of interest.

In other of these embodiments a region of interest can be specified by the user using a pointing system included with the mobile computing device to indicate the boundaries of the region of interest on a map displayed on the screen. And in still other of these preferred embodiments, a region of interest can be specified as only being of interest during at least one specified time period.

In preferred embodiments, the mobile client software system is able to supply location-relevant information to the data exchange core for distribution to other devices. In some of these preferred embodiments the mobile client software system is able to specify restrictions regarding distribution of location-relevant information supplied by the mobile client software system to the data exchange core. And in some of these embodiments the restrictions can include one or more of the following: limiting the number of recipients that can receive the location-relevant information; allowing only members of a specified group to receive the location-relevant information; allowing the location-relevant information to be supplied only during specified time periods; and allowing the location-relevant information to be supplied only to devices located within a specified region.

In various preferred embodiments the data exchange core is able to supply location-relevant information to the mobile computing device using information push, the information push being at least one of synchronous asynchronous. And in some of these preferred embodiments, the data exchange core is able to automatically adjust the timing of the delivery of location-relevant information to the mobile computing device according to the charging state of a battery included in the mobile computing device and/or the quality of the wireless communication between the mobile computing device and the data exchange core.

In preferred embodiments the location-relevant information can include one or more of the following: social communications transmitted between acquaintances; information provided by business establishments to prospective customers; transactional messages exchanged between an establishment and a customer; information provided by an organization to its members; information provided by an organization regarding services that it is willing to offer; reviews of products for the benefit of peers who may consider purchasing similar products; reviews of services for the benefit of peers who may consider using similar services; peer-to-peer advertising of products; and peer-to-peer advertising of services.

In certain preferred embodiments the display screen is able to display locations on the map using visual indications that include visually distinguishable properties, the visually distinguishable properties, such as shape, color, size brightness, and level of color saturation, the visually distinguishable properties being able to indicate properties of an information item such as a category, a selection state, and the duration of time since an information item was provided to the data exchange core.

In some preferred embodiments the data exchange core is able to exchange location-relevant information with a web browsing device in essentially the same manner as the data exchange core is able to exchange location-relevant information with the mobile computing device. In other preferred embodiments the data exchange core is able to apply fuzzy logic to a request for location-relevant information, the fuzzy logic being able to adjust the request so as to respond with a desired quantity of location-relevant information.

In other preferred embodiments the data exchange core is able to automatically complete transactions between users of devices in communication with the data exchange core. And in some preferred embodiments the data exchange core is able to interact with a suitably configured transaction processing system so as to allow the transaction processing system to complete a transaction submitted to the data exchange core by a user of a device in communication with the data exchange core.

In another general aspect of the invention, the method includes providing a mobile client software system having a set of instructions for controlling a mobile computing device, the mobile client software system being able to request location relevant information from a data exchange core, receive location-relevant information from the data exchange core, display a map on a display screen of the computing device, and identify on the map at least one location that corresponds to location-relevant information received from the data exchange core.

### BRIEF DESCRIPTION OF THE DRAWINGS

FIG. 1A is a simplified diagram showing that the data exchange core of the present invention includes both device server functionality and data storage server functionality;

FIG. 1B is a functional diagram of a preferred embodiment showing a plurality of mobile devices, a plurality of mobile device servers, a plurality of web browsing devices, and a plurality of web servers;

FIG. 1C is a functional diagram of a preferred embodiment showing a plurality of mobile devices and web browsing devices exchanging location-relevant information with the data exchange core;

FIG. 1D is a functional diagram of the embodiment of FIG. 1C showing location-relevant information being supplied to the data exchange core by a single mobile device, and being distributed by the data exchange core to a plurality of other devices;

FIG. 2A is an illustration from the front of a mobile computing device of a preferred embodiment, showing locations of interest on a map displayed on a screen;

FIG. 2B is an illustration from the front of the mobile computing device of FIG. 2A, showing a list of location-relevant information items displayed on the screen;

FIG. 2C is an illustration from the front of the mobile computing device of FIG. 2A, showing an expanded display on the screen of a single location-relevant information item;

FIG. 2D is an illustration from the front of the mobile computing device of FIG. 2A, showing a selection menu displayed on the screen that is used to submit subscriptions so as to receive synchronously and asynchronously pushed location-relevant information;

FIG. 2E is an illustration from the front of the mobile computing device of FIG. 2A, showing button icons overlaid on the map that can be used to take actions relating to received location-relevant information;

FIG. 2F is an illustration from the front of the mobile computing device of FIG. 2A, showing information on the screen received in response to completing a transaction using the mobile device, including a verification Data Matrix pattern;

FIG. 3 is a block diagram illustrating functional elements of a mobile computing device of a preferred embodiment;

FIG. 4 is a flow diagram that illustrates the interaction during a proactive query between a mobile computing device or web browsing device and a mobile device server or web server;

FIG. 5A is a flow diagram that illustrates the activity of a mobile computing device during an asynchronous information push;

FIG. 5B is a flow diagram that illustrates the activity of a web browsing device during an asynchronous information push;

FIG. 5C is a flow diagram that illustrates the activity of a mobile device server in providing information relevant to the current location of the mobile computing device; and

FIG. 5D is a flow diagram that illustrates the activity of a web server in providing location-relevant information; and

FIG. 6 is a conceptual diagram that indicates automatic definition of a region of interest according to locations occupied by the mobile device and amounts of time spent by the device at each location.

### DETAILED DESCRIPTION OF PREFERRED EMBODIMENTS

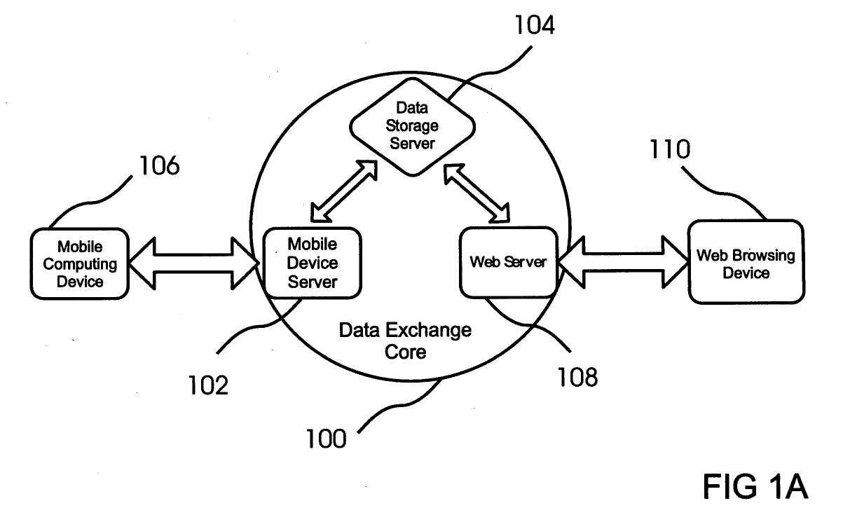

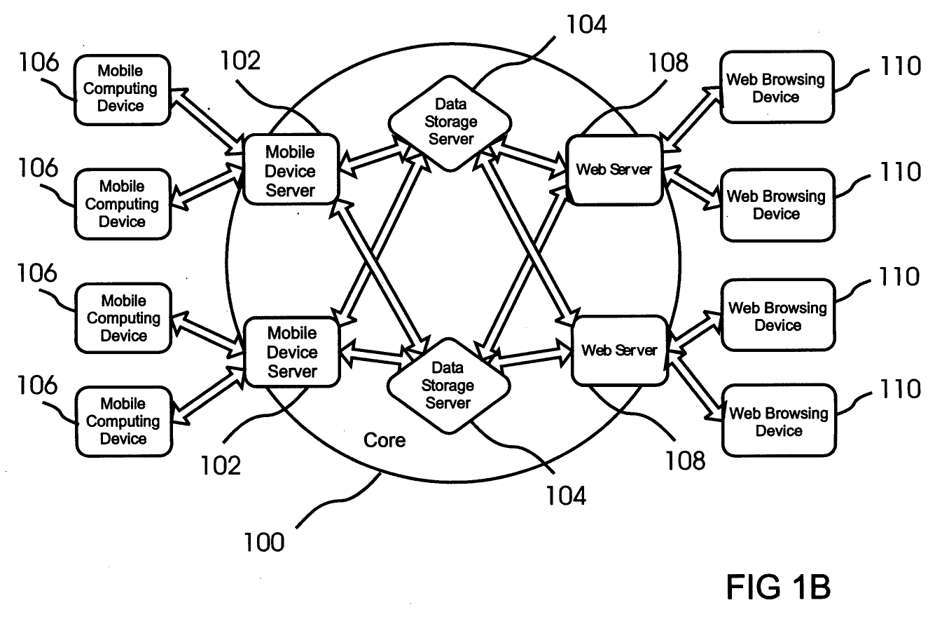

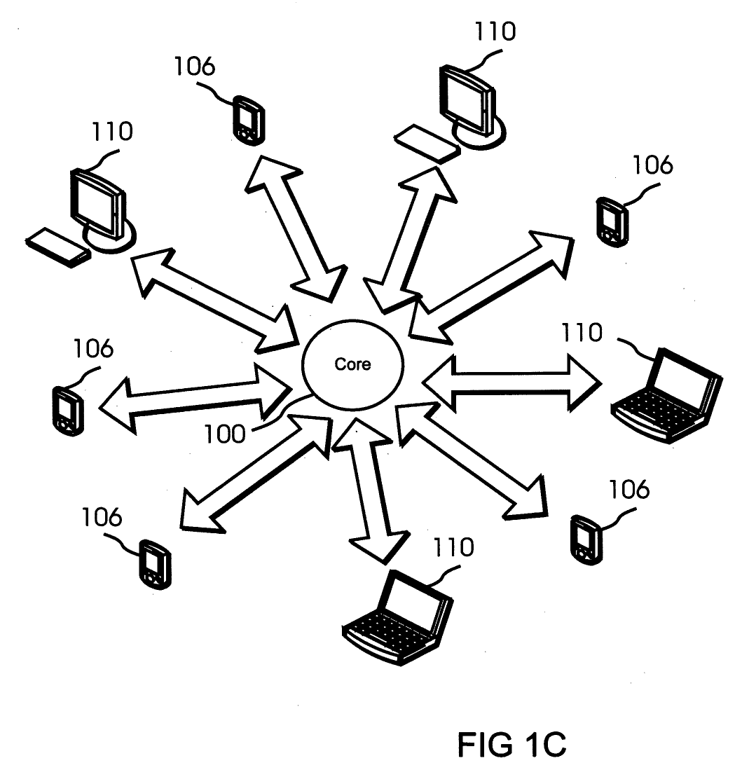

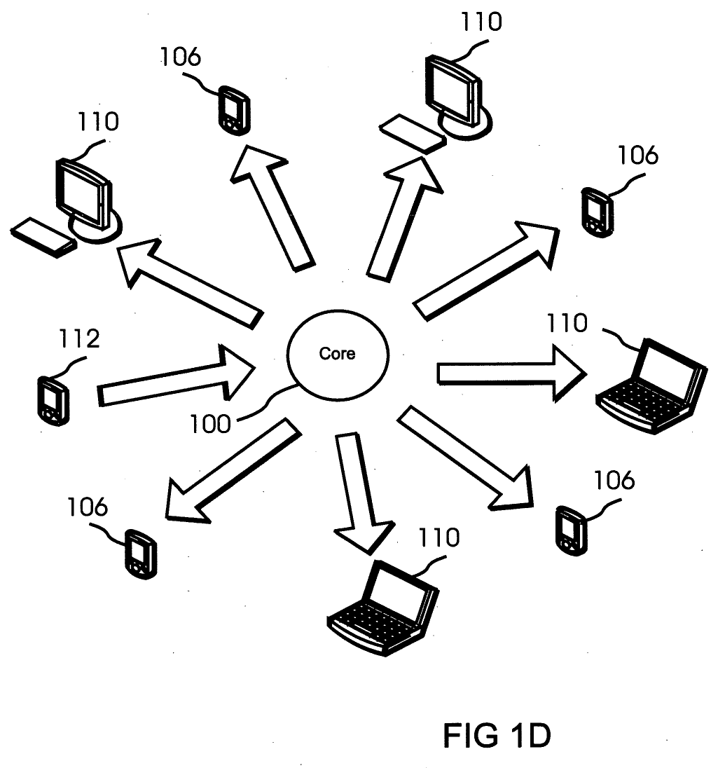

With reference to FIG. 1A, the method of the present invention includes providing a data exchange core 100 including the functionality of a mobile device server 102 and a searchable data storage server 104, the data storage server 104 being able to receive, store, and update location-relevant information, and perform searches on the stored information. The method further includes providing mobile application client software that is operable on a mobile computing device 106 and used to wirelessly communicate with the core 100, so as to supply and receive location-relevant information.

In preferred embodiments, the system also includes a web server 108 that is able to communicate with a web browser operating on a web browsing device 110 such as a desktop PC. In various preferred embodiments, the functionalities indicated as part of the data exchange core 100 are physically distributed in different ways, with a single indicated functionality actually distributed over several physical servers, or with several indicated functionalities actually combined within a single server.

For example, with reference to FIG. 1B, in some embodiments the system includes a plurality of mobile device servers 102 at least in communication with a plurality of data storage servers 104. A plurality of mobile computing devices 106 are used to communicate with the data exchange core 100, and a plurality of web servers 108 communicate with web browsing devices 110.

FIG. 1C illustrates the communication between a data exchange core 100 and a plurality of mobile 106 and web browsing 110 devices. In various preferred embodiments, information can be obtained by the devices 106, 110 through proactive queries, or some or all of the information can be “pushed” to the devices 106, 110, by the data exchange core 100, synchronously and/or asynchronously. In proactive query mode, a remote device 106, 110 is used to compose a request for information and transmits the request to the core 100. A search is immediately performed on the data storage servers 104 in the core 100, a reply is transmitted to the originating device 106, 110, and the reply is presented to the user as soon as it is available.

In “pushed” mode, a request for information sent to the data exchange core 100 can include parameters that describe how frequently and for how long the information is desired. Information is then “pushed” by the data exchange core 100 to the requesting device 106, 110 according to these parameters. In a synchronous push, a request for information results in a direct response, and the user is immediately notified when the information arrives from the data exchange core 100. In an asynchronous push, information is retained temporarily by the data exchange core, and is transmitted to the remote device 106, 110 periodically or at convenient times. Once the information is delivered, the user may or may note be notified, depending on user-specified preferences.

For example, in preferred embodiments a user can use a mobile computing device 106 to initiate a subscription to receive schedules from local theaters. The data exchange core 100 can then assemble the requested information and supply it as an asynchronous push to the mobile computing device 106 at times when the wireless communication bandwidth usage is light and the battery charging level of the mobile computing device 106 is high. The user can then retrieve the information from the mobile computing device 106 whenever it is convenient. Upon identifying a performance of interest, the user can then use the mobile computing device 106 to purchase a ticket from the theater. The resulting confirmation from the theater regarding the ticket purchase can be delivered by a synchronous push, thereby informing the user immediately that the transaction has been accepted.

In some preferred embodiments, the data exchange core can enable one user of a mobile computing device 106 to complete a transaction with another user of a mobile computing device 106. Depending on the embodiment and on the circumstances, if both users are actively communicating with the data exchange core 100 at the same time, the data exchange core 100 can immediately complete the transaction in synchronous mode. In some embodiments, a user can provide certain information to the core 100, such as the sales price and the number of items for sale, and the core can complete transactions automatically. In still other preferred embodiments, the core 100 includes an Application Programmer's Interface (API) that can be used to interface an internal sales transaction system to the data exchange core 100. For example, a restaurant may have a reservation processing system that can be interfaced to the data exchange core 100 using the API. In these embodiments, a user can use a mobile computing device 106 to place a reservation in the restaurant's internal reservation system via the data exchange core 100.

In preferred embodiments, a remote device 106, 110 can be used to submit location-relevant information to the data exchange core 100 for distribution to other remote devices 106, 110. This provides for peer-to-peer communication regarding items and services for sale, reviews of restaurants and stores, communication between members of social groups regarding their current locations and activities, and such like. In FIG. 1D, one of the mobile computing devices 112 from FIG. 1C is shown providing location-relevant information to the data exchange core 100, which is then transmitted to other remote devices 106, 110. For example, someone who has just eaten in a restaurant can use a mobile computing device 112 of the present invention to provide information to the data exchange core 100 regarding the quality of the food, which specific dishes were tried, the quality of the service, which specific server provided the service, and such like. Other users who are located nearby and who are looking for a restaurant can then submit queries to the data exchange core 100 using similar remote devices 106, 110 and obtain the relevant, peer-to-peer information from the data exchange core 100 regarding the restaurant.

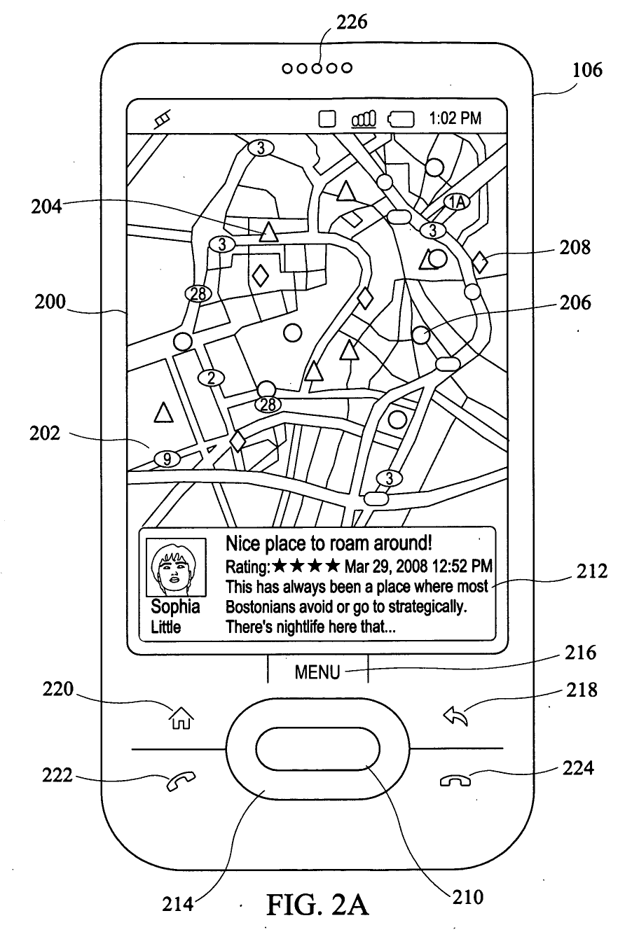

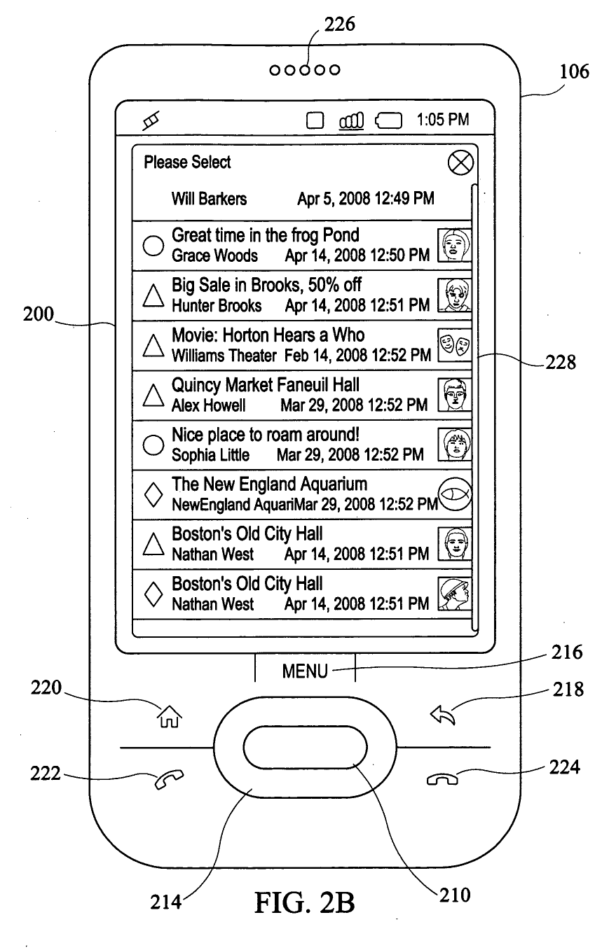

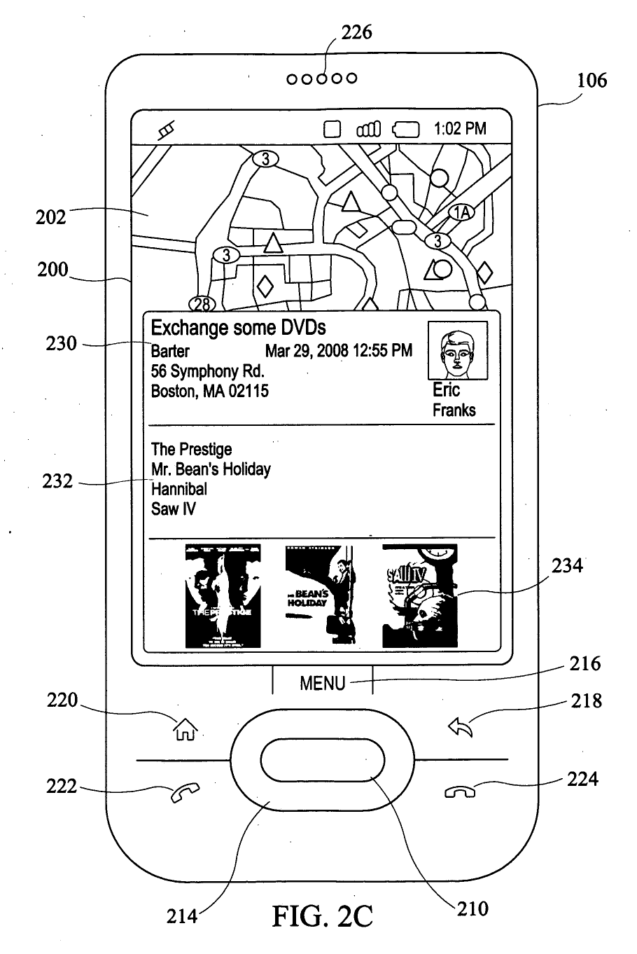

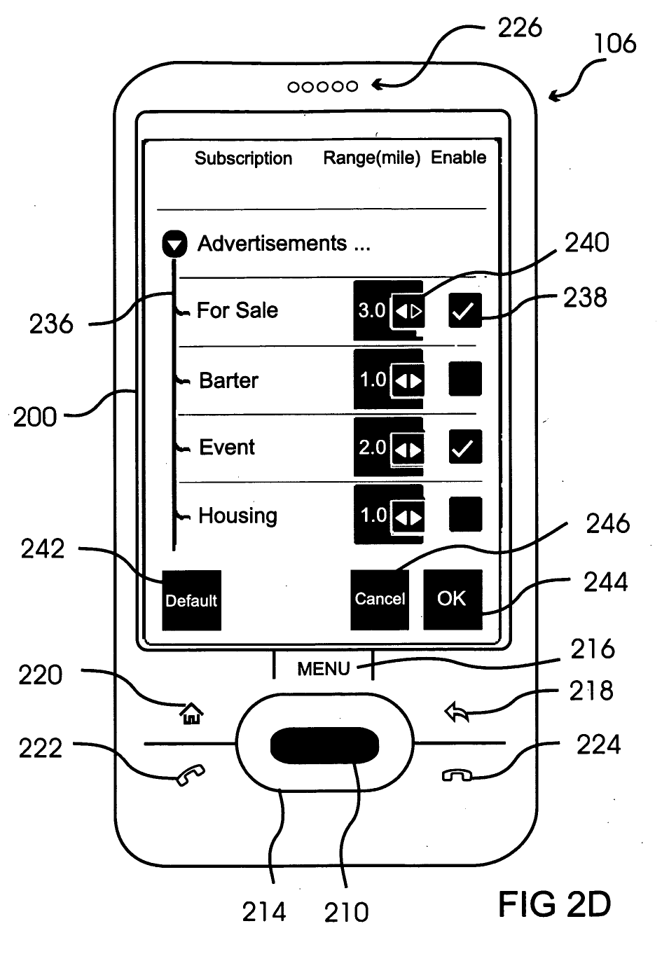

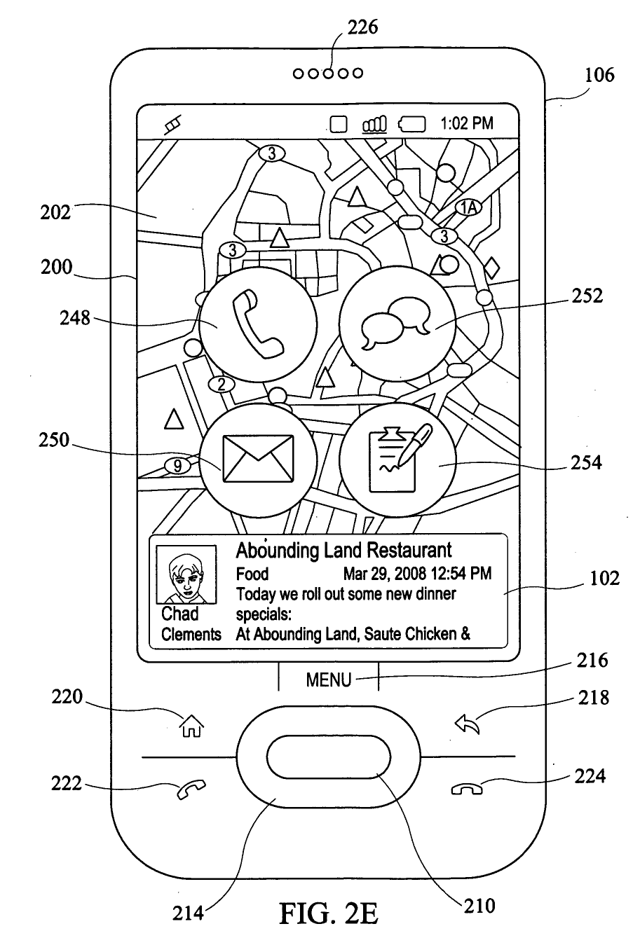

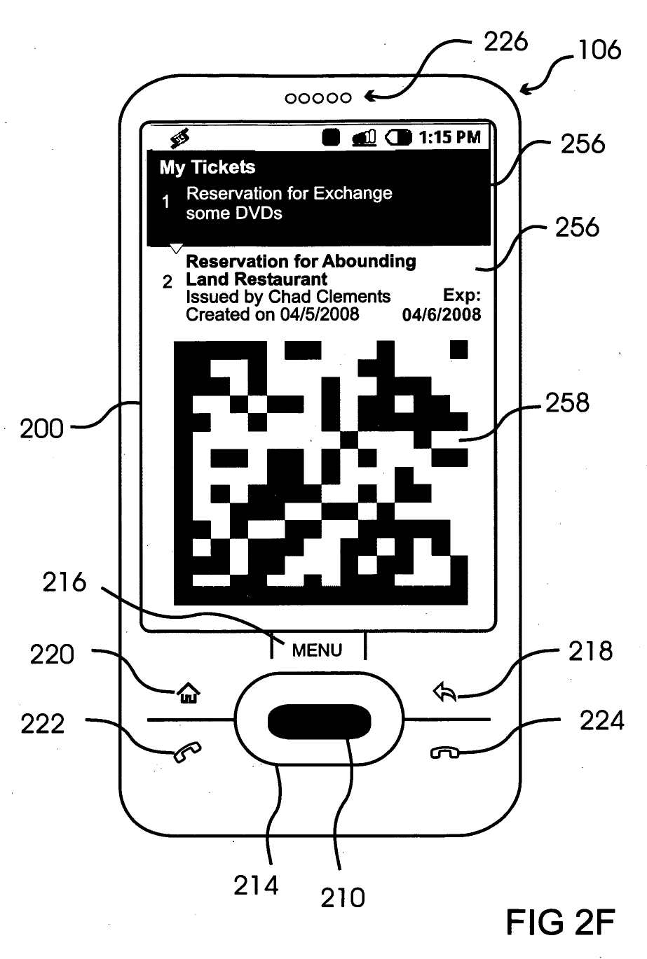

FIG. 2A illustrates a typical mobile computing device 106 used by embodiments of the present invention. The device includes a screen 200 on which a map 202 can be displayed. The map 202 can present locations related to location-relevant information received by the device 106. In the embodiment of FIG. 2A, these locations are indicated according to categories by symbols of different shapes and colors. Green triangles 204 indicate advertisements, blue circles 206 indicate social “blogs,” and red diamonds 208 indicate peer-provided information and tips for visitors not familiar with the area. In the embodiment of FIG. 2A, a selected item is displayed with a brighter intensity, and the saturation of the color of an item indicates how recently the information was received by the data exchange core, with older items finally fading to grey before being removed from the map 202. In other preferred embodiments, other visually distinguishable properties, such as the size of an item, are used to indicate properties of corresponding information. And in some embodiments more sophisticated shapes are used, such as a fork-shaped indication to show the location of a restaurant, a gas-pump-shaped indication to show the location of a gas station, and/or a house-shaped indication to show the location of a hotel.

In the preferred embodiment of FIG. 2A, a pointing system 210 is included so as to allow selection of information presented on the screen 200, and so as to allow locations and regions on the map 202 to be selected as locations and regions of interest for queries to the data exchange core 100. Alternatively, items, locations, and regions on the map 202 can be selected by simply touching the screen 200, either with a finger or with a stylus. In this case, the touch-sensitive screen 200 serves as the pointing system 210. When a displayed item, such as a location marked by a triangle 204, a circle 206, or a diamond 208, is selected, the selected item is displayed with more brightness, and information relating to the selected location 212 is displayed on a portion of the screen 200.

Full control of the mobile computing device 106 is gained by using a selector ring 214 to cause a menu to appear on the screen 200, and by toggling through the menu using a menu button 216. The selector ring 214 can also be used to back up one menu level 218, and return to a “home” menu level 220. In the preferred embodiment of FIG. 2A, the mobile computing device also functions as a cellular telephone. The selector ring 214 can be used in this regard to initiate 222 and terminate 224 telephone calls, and holes 226 at the top of the device 106 provide for transmitting of audible sound. The microphone for the cellular telephone function is located just below the base of the device 106, and is not visible in the figure.

FIG. 2B shows the mobile computing device 106 of FIG. 2A with a list of location-relevant information items 228 displayed on the screen 200, corresponding to all of the locations indicated on the map 202 of FIG. 2A. When necessary, the list 228 can be scrolled using the pointing system 210 or by moving a stylus or a finger tip across the touch-sensitive screen 200. A specific item can be selected from the displayed list 228, either by using the pointing system 210 or by tapping on the item in the list 228, thereby causing presentation of a verbose display of all received information for that item, as shown in FIG. 2C, including details such as the complete address 230 of the location related to the information, a full description of the information 232, and non-text content 234 such as pictures, audio and video.

FIG. 2D shows the mobile computing device 106 of FIG. 2A with a display on the screen 200 that can be used to subscribe to “pushed” information. Primary categories 236 of information are listed on the screen 200, and can be selected by checking boxes 238 next to the categories 236. A distance in miles can also be indicated 240 so as to indicate the size of the region corresponding to which location-relevant information is desired. Other criteria can be specified by selecting appropriate menus, such as information regarding the region of interest. Examples include a fixed distance from a specified location, such as “within 5 miles of my office” or, if the mobile client software or the data exchange core is roadway aware, a fixed travel time or distance from a specified location. If the mobile computing device is location aware, in some preferred embodiments a time threshold can be specified such that any location where the mobile computing device spends an aggregate amount of time that exceeds the time threshold is automatically considered a location of interest, the aggregate being either a lifetime aggregate or an aggregate amount of time per day, week, month, etc.

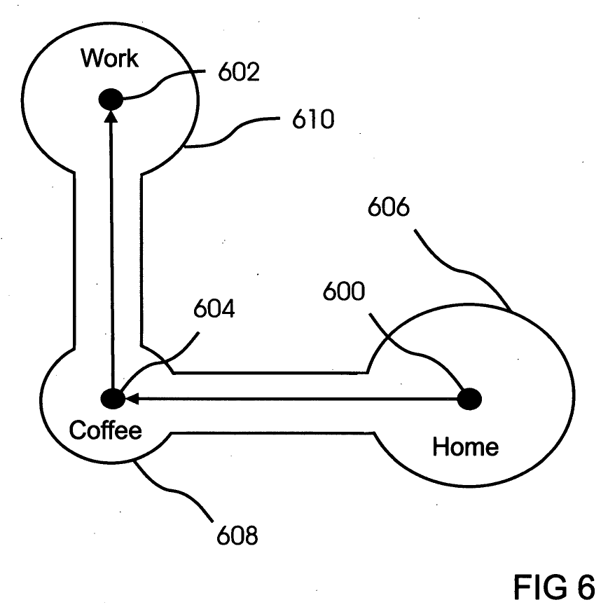

Information can also be entered as to whether a fixed or a “fuzzy” search is requested. In a fuzzy search, if an insufficient quantity of information items is found, then at least one of the search parameters, such as the size of the region of interest, is automatically adjusted until a sufficient number of location-relevant items is found or an upper bound is reached. Regions can be defined either explicitly (for example by using a stylus to trace the boundaries of the region on a map 202 on the screen 200 of the device 106), or by recording movement patterns of a location-aware mobile computing device 106. In some preferred embodiments, the size of a region surrounding a plurality of locations is determined at least partly according to how much time the mobile computing device 106 spends at each of the locations. Thus, a region of interest might include a narrow corridor surrounding a path used to commute to work, and larger regions surrounding a home and an office. This approach is discussed in more detail in reference to FIG. 6 below.

Other criteria that can be specified include a range of time, such as a range of dates or a time range relative to the current time. Information can also be limited according to peer supplied feedback ratings, social distances of the information providers (such as limiting the source to a friend or a social group), and key words or tags. A default button 242 can be selected to automatically set the criteria to default settings, and OK 244 and Cancel 246 buttons can be selected to record or discard selected criteria.

FIG. 2E illustrates a display in a preferred embodiment that can be used to take action based on location-relevant information received on a mobile computing device. Selection of a relevant location 204, 206, 208 displayed on the map 202 causes action button icons 248, 250, 252, 254 to be overlaid onto the map 202. Clicking or tapping on an action button icon initiates an action related to the selected location 204, 206, 208, such as placing a telephone call 248 to the location, sending an email to someone at the location 250, sending a text message to someone at the location 252, or making a reservation 254 for a ticket, a table at a restaurant, and such like. In preferred embodiments, the group of action button icons displayed depends on the information included in the corresponding location-relevant information. For example, an email action button icon will only be displayed if an email address is included in the location-relevant information.

With reference to FIG. 2F, the mobile computing device 106 can be used to initiate and complete location-relevant transactions, such as making reservations at a restaurant or purchasing theater tickets. A list of completed transactions 256 can be displayed on the screen 200, and in the preferred embodiment of FIG. 2F, selecting an item from the list causes a visual pattern such as a Data Matrix 258, a Barcode, or a sequence of letters and numbers to be displayed on the screen 200, the visual pattern serving as a computer-readable receipt or ticket.

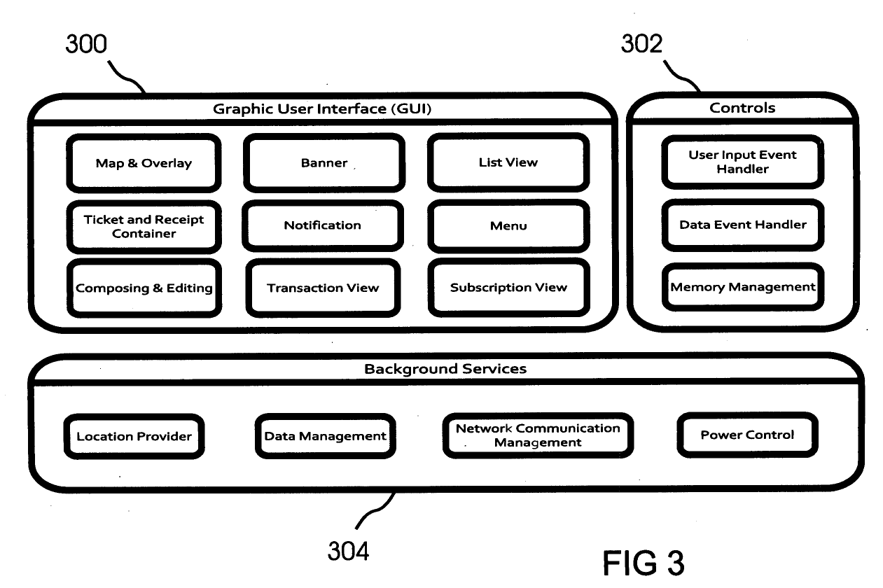

FIG. 3 illustrates the software architecture of a mobile computing device 106 of a preferred embodiment, including software elements that manage the graphical user interface 300, elements that manage the controls 302, and background services 304 that support all of the operations of the mobile computing device 106.

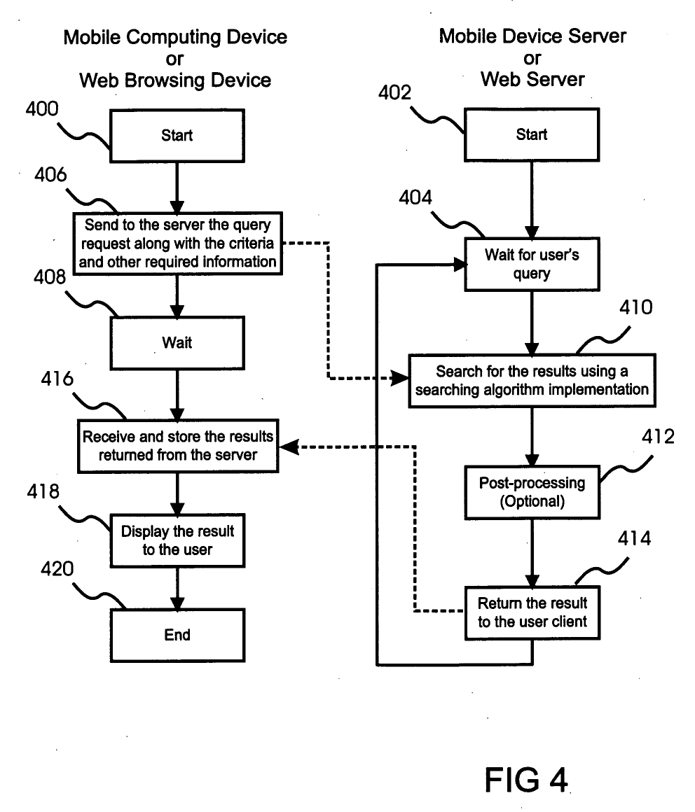

As is mentioned above with reference to FIG. 1C, information can be obtained by remote devices 106, 110 through proactive queries, or some or all of the information can be “pushed” to the devices 106, 110, by the data exchange core 100, either synchronously and/or asynchronously. FIG. 4 illustrates the interaction during a proactive query between a mobile computing device 106 running mobile device client software or a web browsing device 110 running web browser software and a mobile device server 102 or a web server 108. After initializing the device 400 and the server 402, the server waits 404 for a query. When a query 406 is sent by the device to the server, the device waits for a response 408 while the server initiates a search 410 of the data storage server 102, and then optionally performs some post-processing 412, such as filtering or reformatting, on the results. The server then returns the results to the remote device 414, and the remote device receives the results, stores them 416, and presents the results 418 to the user, thereby completing the process 420.

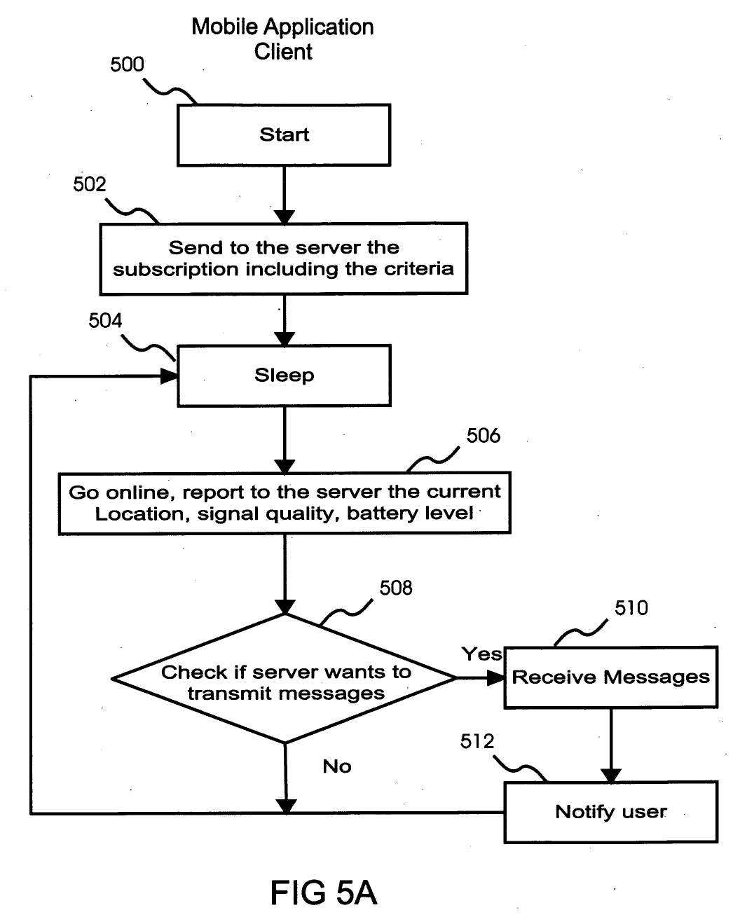

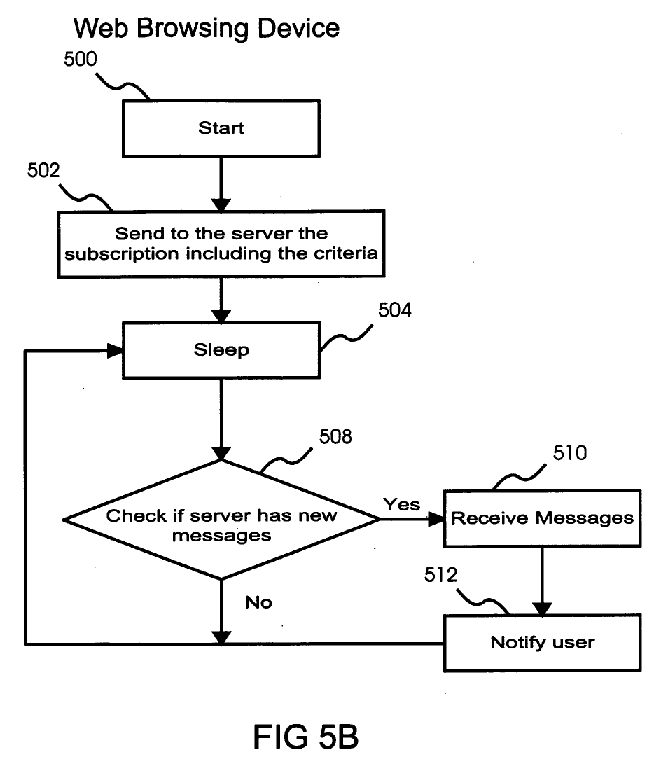

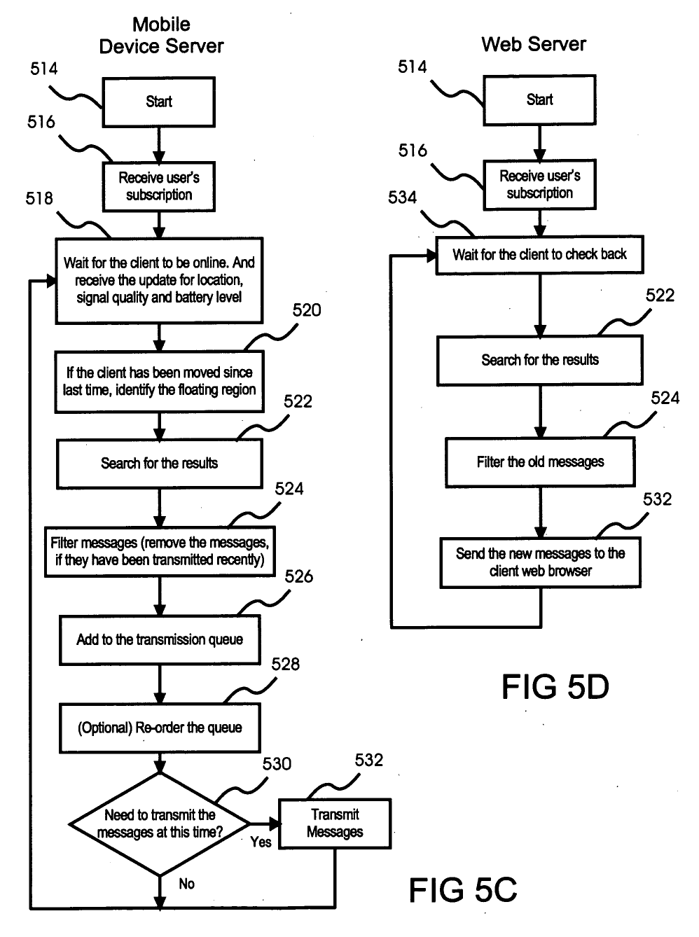

FIG. 5A, FIG. 5B, FIG. 5C, and FIG. 5D illustrate the interaction during an asynchronous information push between a mobile computing device 106 running mobile device client software or a web device 110 running web browser software and a mobile device server 102 or a web server 108. FIG. 5A illustrates the steps taken by a mobile computing device 106 running mobile device client software when requesting information relevant to a region surrounding its current location. After initialization 500, information is sent 502 to the mobile device server 102 requesting a subscription to a certain type of information, and including criteria such as a range of time, limitation to certain peer groups, and such like. For example, groups with different relationship distances can be defined, such as “close friends,” “acquaintances,” “friends-of-friends,” “members of the same organization,” “alumni of the same college,” etc, and a limitation can be specified in terms of a maximum relationship distance, such as the maximum relationship distance of the person supplying the information to the data exchange core.

The device 106 then waits 504. At a later time, the device 106 transmits information 506 to the server 102 regarding its position, the wireless telephone signal quality, and the charging state of its battery. It then checks 508 to see if the server 102 wishes to transmit any information in response to the query. If so, the device 106 receives the information 510 and notifies the user 512. As illustrated in FIG. 5B, the same steps are followed by a web browsing device, except that considerations regarding the current location of the device, wireless communication signal strength, and battery charging state do not apply.

FIG. 5C illustrates the steps taken by a mobile device server 102 during an asynchronous information push in coordination with the steps illustrated in FIG. 5A taken by a mobile computing device 106. After initialization 514, the server 102 receives the subscription information 516 from the device 106, and then waits for the device 106 to be online 518 (i.e. to make contact by wireless communication), whereupon the server 102 receives an update from the device 106 regarding the location, signal quality, network congestion, and battery charge state of the device 106. The server 102 then determines if the device 106 has moved 520 since the last contact.

If the device 106 has moved, the server 102 takes steps to define and/or update a region of interest based on a plurality of locations occupied by the device at different times, and optionally based on the amount of time spent at each location. This step is discussed in more detail in regard to FIG. 6 below. A search is then initiated 522 based on the query and the current location and/or region of interest of the device 106. The result of the search is filtered 524 to remove information already transmitted to the device 106, and the remaining information is added to a transmission queue 526. In some preferred embodiments, the order of the information in the queue is then reordered 528 according to priorities indicated as criteria by the device 106. Depending on priorities indicated by the device 106 and on factors such as the signal strength, network congestion, and battery charge state, the server 102 then decides 530 if a transmission of information is appropriate. If so, part or all of the information in the queue is transmitted 532 to the device 106.

As is illustrated in FIG. 5D, a similar but simplified series of steps is followed by a web server 108 during an asynchronous information push in coordination with the steps illustrated in FIG. 5B taken by a web browsing device 110. After initialization 514, the web server 108 receives the subscription information 516 from the web browsing device 110 and waits for the device 110 to check back 534 for the results. The server 108 then searches for results 522, filters out information 524 already transmitted to the device 110, and sends the new information items 532 to the device 110.

A method of defining of a region of interest according to locations occupied by a mobile computing device 106 is illustrated in FIG. 6. In this example, the user of the mobile computing device 106 travels frequently from his home 600 to his place of work 602, stopping on most mornings to have coffee at a coffee shop 604. The region of interest is defined as surrounding the user's commuting path to and from work, and is adjusted in size according to the amount of time spent at each location. The region surrounding the home location 606 is largest, followed by the region surrounding the work location 608, with the region surrounding the coffee shop 610 being the smallest.

Other modifications and implementations will occur to those skilled in the art without departing from the spirit and the scope of the invention as claimed. Accordingly, the above description is not intended to limit the invention except as indicated in the following claims.

What is claimed is:

1. A method for providing location-relevant information to a mobile computing device, the method comprising:
providing a data exchange core including at least one data storage server that is able to receive, store, and update location-relevant information and perform queries thereon; the data exchange core being able to wirelessly communicate with the mobile computing device; and
providing a mobile client software system having a set of instructions for controlling the mobile computing device, the mobile client software system being able to:
request location relevant information from the data exchange core;
receive location-relevant information from the data exchange core;
display a map on a display screen of the computing device; and
identify on the map at least one location that corresponds to location-relevant information received from the data exchange core.

2. The method of claim 1, wherein, if the mobile computing device is location-aware, the mobile client software system is able to automatically provide to the data exchange core information allowing determination of at least the approximate location of the mobile computing device.

3. The method of claim 2, wherein, if the mobile computing device is location-aware, at least one of the mobile client software system and the data exchange core is able to accumulate and store information allowing determination of a plurality of at least approximate locations of the mobile computing device for later transmission to the data exchange core.

4. The method of claim 1, wherein the mobile client software system is able to request from the data exchange core location-relevant information that is limited to at least one of:
information belonging to a specified category;
information that is relevant during a specified time period;
information supplied by members of a specified group;
information containing a specified key word;
information to which a specified tag applies; and
information to which a rating has been assigned, the rating being higher than a specified threshold.

5. The method of claim 1, wherein the mobile client software system is able to accept input from a user specifying at least one location of interest.

6. The method of claim 5, wherein a location of interest can be specified by the user by at least one of:
using a pointing system included in the computing device to select the location of interest on a map displayed on the screen;
specifying that the current location of the mobile computing device is the location of interest;
specifying that the location of another mobile computing device is the location of interest; and
entering alphanumeric input into the mobile computing device that specifies the location of interest.

7. The method of claim 5, wherein a plurality of locations of interest can be specified by the user by at least one of:
specifying that locations visited by the mobile computing device are locations of interest;
specifying that locations frequently visited by the mobile computing device are locations of interest;
specifying that locations visited by another mobile computing device are locations of interest; and
specifying that locations frequently visited by another mobile computing device are locations of interest; and
specifying that all locations belonging to a specific category are locations of interest.

8. The method of claim 1, wherein the mobile client software system is able to accept input from a user allowing specification of at least one region of interest, and the mobile client software system is able to request location-relevant information from the data exchange core pertaining to locations within each specified region of interest.

9. The method of claim 8, wherein the mobile client software system is able to accept input from a user specifying a location of interest, and the at least one region of interest can be specified by:
the user specifying at least one location of interest; and
one of the mobile client software system and the data exchange core defining a region of interest according to each specified location of interest by one of:
applying a specified radius to the specified location of interest, so as to define a corresponding region of interest surrounding the specified location of interest; and
combining roadway awareness with one of a specified travel time and a specified travel distance so as to define a region of interest surrounding the specified location of interest.

10. The method of claim 9, wherein, if the mobile computing device is location aware, at least one of the mobile client software system and the data exchange core can automatically maintain a history of time spent by the mobile computing device at locations, and the size of a region of interest surrounding a location of interest can be automatically adjusted according to the amount of time spent by the mobile computing device at the location of interest.

11. The method of claim 8, wherein a region of interest can be specified by the user using a pointing system included with the mobile computing device to indicate the boundaries of the region of interest on a map displayed on the screen.

12. The method of claim 8, wherein a region of interest can be specified as only being of interest during at least one specified time period.

13. The method of claim 1, wherein the mobile client software system is able to supply location-relevant information to the data exchange core for distribution to other devices.

14. The method of claim 13, wherein the mobile client software system is able to specify restrictions regarding distribution of location-relevant information supplied by the mobile client software system to the data exchange core.

15. The method of claim 14, wherein the restrictions can include:
limiting the number of recipients that can receive the location-relevant information;
allowing only members of a specified group to receive the location-relevant information;
allowing the location-relevant information to be supplied only during specified time periods; and
allowing the location-relevant information to be supplied only to devices located within a specified region.

16. The method of claim 1, wherein the data exchange core is able to supply location-relevant information to the mobile computing device using information push, the information push being at least one of synchronous asynchronous.

17. The method of claim 16, wherein the data exchange core is able to automatically decide when to deliver location-relevant information to the mobile computing device according to at least one of:
the charging state of a battery included in the mobile computing device;
the quality of the wireless communication between the mobile computing device and the data exchange core; and
the congestion of the communication link between the mobile computing device and data exchange core.

18. The method of claim 1, wherein the location-relevant information can include:
social communications transmitted between acquaintances;
information provided by business establishments to prospective customers;
transactional messages exchanged between an establishment and a customer;
transactional messages exchanged between peers;
information provided by an organization to its members;
information provided by an organization regarding services that it is willing to offer;
information provided by an organization regarding an item that it is willing to sell;
reviews of products for the benefit of peers who may consider purchasing similar products;
reviews of services for the benefit of peers who may consider using similar services;
peer-to-peer advertising of products;
peer-to-peer advertising of services;
peer-to-peer advertising of activities; and
peer-to-peer advertising of events.

19. The method of claim 1, wherein the display screen is able to display locations on the map using visual indications that include visually distinguishable properties, the visually distinguishable properties including at least one of shape, color, size, brightness; level of color saturation, and other visually distinguishable properties, each visually distinguishable property indicating at least one of:
a category of an information item;
a selection state of an information item;
a length of time since the information item was supplied to the data exchange core; and
other information item properties.

20. The method of claim 1, wherein the data exchange core is able to exchange location-relevant information with a web browsing device in essentially the same manner as the data exchange core is able to exchange location-relevant information with the mobile computing device.

21. The method of claim 1, wherein the data exchange core is able to apply fuzzy logic to a request for location-relevant information, the fuzzy logic being able to adjust the request so as to respond with a desired quantity of location-relevant information.

22. The method of claim 1, wherein the data exchange core is able to automatically complete transactions between users of devices in communication with the data exchange core.

23. The method of claim 1, wherein the data exchange core includes an interface that allows it to interact with a suitably configured transaction processing system so as to allow the transaction processing system to complete a transaction submitted to the data exchange core by a user of a device in communication with the data exchange core.

24. The method of claim 1, wherein the mobile client software system is able to display on the screen at least one of a Data Matrix, a Barcode, and other visual patterns so as to provide optically scannable evidence of the completion a transaction.

25. A method for providing location-relevant information to a mobile computing device, the method comprising:
providing a mobile client software system having a set of instructions for controlling the mobile computing device, the mobile client software system being able to:
request location relevant information from a data exchange core;
receive location-relevant information from the data exchange core;
display a map on a display screen of the computing device; and
identify on the map at least one location that corresponds to location-relevant information received from the data exchange core.
